(19) United States
(12) Patent Application Publication
(10) Pub. No.: US 2016/0072839 A1
(43) Pub. Date: Mar. 10, 2016

(54) FACILITATING DYNAMIC MANAGEMENT OF PARTICIPATING DEVICES WITHIN A NETWORK IN AN ON-DEMAND SERVICES ENVIRONMENT

(71) Applicant: salesforce.com, inc., San Francisco, CA (US)

(72) Inventor: William Charles Mortimore, JR., San Francisco, CA (US)

(21) Appl. No.: 14/478,795

(22) Filed: Sep. 5, 2014

(51) Int. Cl. H04L 29/06

(52) U.S. Cl. CPC H04L 63/20

(57) ABSTRACT

In accordance with embodiments, there are provided mechanisms and methods for facilitating dynamic management of devices participating in a network in an on-demand services environment in an on-demand services environment in a multi-tenant environment according to one embodiment. In one embodiment and by way of example, a method includes receiving, by and incorporating into a database system, a policy document relating to a first computing device over a network, the network including Internet of Things (“IoT”), verifying, by the database, the first computing device based on contents of the policy document, and authorizing, by the database, the first computing device to participate within the network, where participating includes performing one or more tasks within the network on behalf of a user and in accordance with the policy document.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to a mechanism for facilitating dynamic management of participating devices within a network in an on-demand services environment.

### BACKGROUND

With the increase in the number and type of networks and devices that participate in such networks, there is an increased need for the devices to be efficient in working on behalf of their users. However, most participating devices, such as washing machines, thermostats, etc., include only minimal capabilities and lack technological sophistication to sufficiently act on behalf of their users.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a computing device employing a dynamic device management mechanism according to one embodiment;

FIG. 2 illustrates a dynamic device management mechanism according to one embodiment;

FIG. 3 illustrates a transaction sequence for facilitating dynamic management of devices participating in a network according to one embodiment;

FIG. 4 illustrates a method for facilitating dynamic management of devices participating in a network according to one embodiment;

FIG. 5 illustrates a computer system according to one embodiment;

FIG. 6 illustrates an environment wherein an on-demand database service might be used according to one embodiment; and

FIG. 7 illustrates elements of environment of FIG. 6 and various possible interconnections between these elements according to one embodiment.

### SUMMARY

In accordance with embodiments, there are provided mechanisms and methods for facilitating dynamic management of participating devices within a network in an on-demand services environment in an on-demand services environment in a multi-tenant environment according to one embodiment. In one embodiment and by way of example, a method includes receiving, by and incorporating into a database system, a policy document relating to a first computing device over a network, the network including Internet of Things (“IoT”), verifying, by the database, the first computing device based on contents of the policy document, and authorizing, by the database, the first computing device to participate within the network, where participating includes performing one or more tasks within the network on behalf of a user and in accordance with the policy document.

While the present invention is described with reference to an embodiment in which techniques for facilitating management of data in an on-demand services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### DETAILED DESCRIPTION

Methods and systems are provided for facilitating dynamic management of participating devices within a network in an on-demand services environment in a multi-tenant environment according to one embodiment.

Embodiments provide facilitating devices to efficiently provide data and act on behalf of their users in a network, such as Internet of Things (IoT) (also referred to as “Cloud of Things” or simply “CoT”). It is contemplated that although many of the devices participating in a network like IoT may have basis and necessary computing capabilities, but they may not be sophisticated enough to have the necessary processing capabilities or sufficient power to efficiently work on the users' behalf. For one reason, this may be because IoT serves to accommodate a large number and various types of devices and thus, such devices may be dumb or having only the basic computing capability to participate in IoT. For example, such minimal computing capability devices participating in IoT may include (without limitation) washing machines, dryers, watches, wristbands, bangles, home security systems, thermostats, automobile computers, heart monitors, transponders, sensors, etc.

Embodiments provide a model where an application receives a token on behalf of a dumb participating device. This token can be given to the device and allow it to function autonomously when talking to the cloud back end. Further, the token may carry delegation capabilities to act on behalf of the user in a given capacity.

Embodiments provide for a mechanism to facilitate a sharing and engaging capability for such minimal capability devices to be authenticated and used within the network in a manner that is more efficient and engaging on behalf of their users. For example and in one embodiment, the aforementioned mechanism may include a supporting software application to be hosted by a server computer or, in another embodiment, at a capable client computer (e.g., mobile computing device, tablet computer, etc.), where the software application may be accessed by a user to manipulate (e.g., via a barrier token) authentication and participation of a minimal device (e.g., washer/dryer, watch, bracelet, hat, etc.) within IoT, where the user has access to both the client computer and the participating minimal device.

Embodiments provide for using a mechanism and one or more local applications to facilitate performing of authentication and management for allowing the user to delegate access to one or more devices (e.g., washer/dryer) participating over a network (e.g., IoT) using, for example, a secured policy document. Further, embodiments provide for allowing the user to authenticate himself or herself while securely paring the participating device (e.g., washer/dryer) with their own account and/or base computer (e.g., mobile computer, etc.) to facilitate the participating device to act on the user's behalf in a constrained or any particular manner as determined and authorized by the user.

It is contemplated that embodiments and their implementations are not merely limited to multi-tenant database system (“MTDBS”) and can be used in other environment, such as a client-server system, a mobile device, a personal computer (PC), a web services environment, etc. However, for the sake of brevity and clarity, throughout this document, embodiments are described with respect to a multi-tenant database system, such as Salesforce.com®, which is to be regarded as an example of an on-demand environment.

In conventional models, index tables are severely limited in that an index table can only be created, for example, by a limitation of up to 2 columns and each column with up to 3 data types. As a result, a large number of index tables and/or skinny tables are required to be created and maintained and further, when they are relied upon for reference (such as when customer queries are to be processed) which can all be expensive, inefficient, and not scalable.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like without departing from the scope of the embodiments claimed.

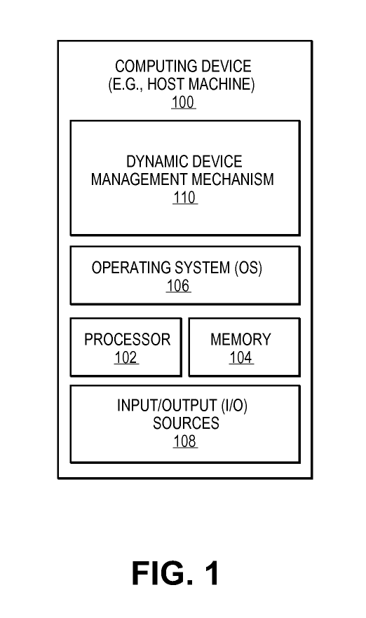

FIG. 1 illustrates a computing device 100 employing a dynamic device management mechanism 110 according to one embodiment. In one embodiment, computing device 100 serves as a host machine for employing dynamic device management mechanism (“management mechanism”) 110 for facilitating dynamic control of devices participating in a network in a multi-tiered, multi-tenant, on-demand services environment.

The “user” may refer to an individual or a group of individuals having access to one or more devices participating in a network (e.g., IoT), ranging from any number and type of minimal capability devices to any number and type of maximum capability devices within the network. The term “user” may also refer to a system user, such as, but not limited to, a software/application developer, a system administrator, a database administrator, an information technology professional, a program manager, product manager, etc. The term “user” may further refer to an end-user, such as, but not limited to, an organization (e.g., a business, a company, a corporation, a non-profit entity, an institution, an agency, etc.) serving as a customer or client of the provider (e.g., Salesforce.com®) of management mechanism 110 or an organization's representative, such as a salesperson, a sales manager, a product manager, an accountant, a director, an owner, a president, a system administrator, a computer programmer, an information technology (IT) representative, etc.

It is to be noted that any references to software codes, data and/or metadata (e.g., Customer Relationship Model (CRM) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com Ape™ code, JavaScript™, jQuery™, Developerforce™, Visualforce™, Service Cloud Console Integration Toolkit™ (“Integration Toolkit” or “Toolkit”), Platform on a Service™ (PaaS), Chatter® Groups, Sprint Planner®, MS Project®, etc.), domains (e.g., Google®, Facebook®, LinkedIn®, Skype®, etc.), protocols or standards (e.g., authentication protocols (e.g., OAuth, Extensible Markup Language Advanced Electronic Signatures (“XAdES”) protocol, etc.), barrier/security tokens (e.g., OAuth 2.0 JavaScript Object Notation (“JSON”) Web Token (“JWT”)), refresh tokens (e.g., OAuth 2.0 refresh token, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

Computing device 100 may include server computers (e.g., cloud server computers, etc.), desktop computers, cluster-based computers, set-top boxes (e.g., Internet-based cable television set-top boxes, etc.), etc. Computing device 100 may also include smaller computers, such as mobile computing devices, such as cellular phones including smartphones (e.g., iPhone® by Apple®, BlackBerry® by Research in Motion® Limited, now known and trading as BlackBerry®, etc.), handheld computing devices, personal digital assistants (PDAs), etc., tablet computers (e.g., iPad® by Apple®, Galaxy® by Samsung®, etc.), laptop computers (e.g., notebooks, netbooks, Ultrabook™ systems, etc.), e-readers (e.g., Kindle® by Amazon.com®, Nook® by Barnes and Nobles®, etc.), Global Positioning System (GPS)-based navigation systems, cable setup boxes, etc.

Computing device 100 includes an operating system (“OS”) 106 serving as an interface between any hardware or physical resources of the computing device 100 and a user. Computing device 100 further includes one or more processors 102, memory devices 104, network devices, drivers, or the like, as well as input/output (“I/O”) sources 108, such as touchscreens, touch panels, touch pads, virtual or regular keyboards, virtual or regular mice, etc. It is to be noted that terms like “node”, “computing node”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “code”, “software code”, “application”, “software application”, “program”, “software program”, “package”, and “software package” may be used interchangeably throughout this document. Moreover, terms like “job”, “input”, “request” and “message” may be used interchangeably throughout this document.

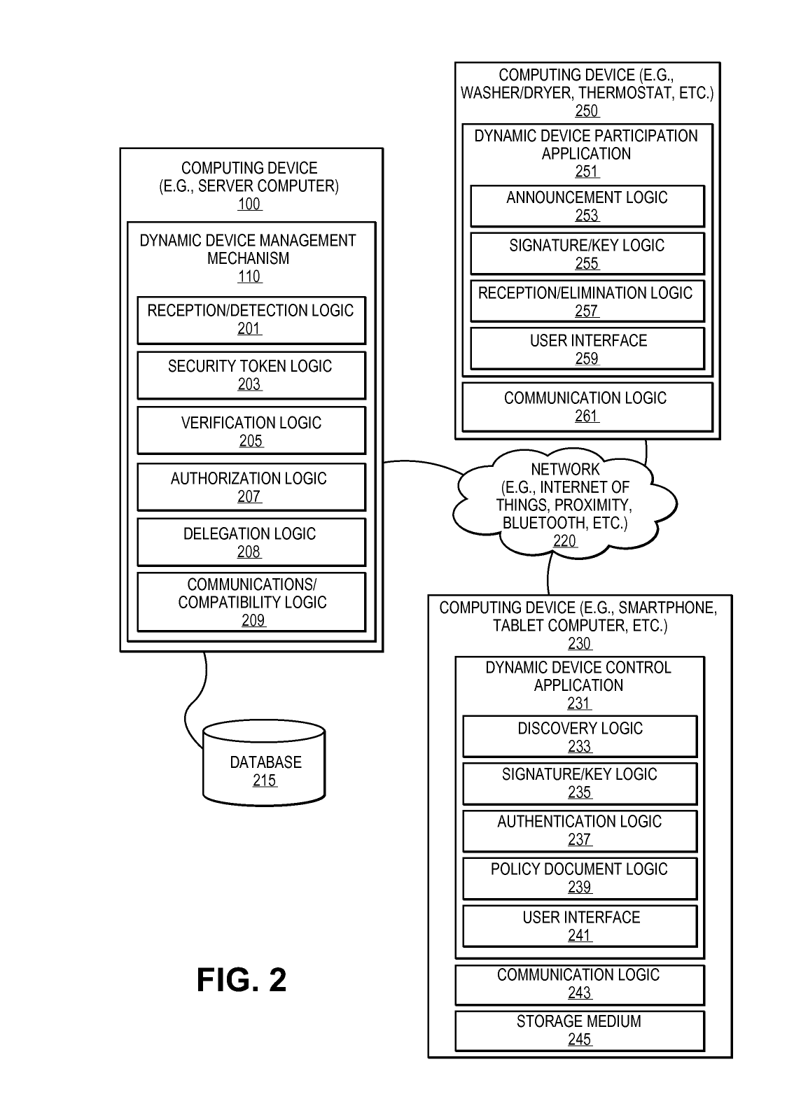

FIG. 2 illustrates a dynamic device management mechanism 110 according to one embodiment. In one embodiment, computing device 100 may host management mechanism 110 may include a number of components, such as (without limitation): reception/detection logic 201, security token logic (“token logic”) 203, verification logic 205, authorization logic 207, and communication/compatibility logic 209. In one embodiment, management mechanism 110 may be employed by a host machine serving as a server computer, such as computing device 100. In another embodiment, one or more components 201-209 of management mechanism 110 may be employed at one or more client computing device, such as a smartphone, laptop computer, etc.

Computing device 100 may be in communication with one or more storage repositories or databases, such as database 220, locally or remotely over one or more networks, such as network(s) 210 (e.g., IoT or CoT). It is contemplated that network 210 may include any number and type of parallel networks or sub-networks (e.g., cloud network, Internet, intranet, local Area Network (“LAN”), proximity network, Bluetooth, WiFi, etc.) over which communication between computing devices 100, 230, 250 may be performed. For example, computing devices 230 and 250 may be connected via IoT, but may also communicate with each other over one or more other networks, such as LAN, proximity network, Bluetooth, etc.

In the illustrated embodiment, computing device (for clarity and ease of understanding, may also be referred to as “server computer”) 100 is shown to be in communication with computing devices 230, 250 over network 220. Client computing device (for clarity and ease of understanding, may also be referred to as “base computer”) 230 may include any number and type of client computing devices, such as workstations, desktop computers, portable or mobile computers, such as laptop computers, tablet computers, smartphones, etc. Client computing device (for clarity and ease of understanding, may also be referred to as “participating device”) 250 may include any number and type of computing devices that participate and performing being part of IoT or CoT, such as network 220. Accordingly, participating device 250 may include a very basic device, such as a bracelet or a shirt, etc., and therefore may employ merely minimal computing and/or networking capabilities that may be sufficient to be part of an IoT environment/network, such as network 220.

Examples of such IoT-participating devices, such as participating device 250, may include virtually anything and everything including one or more of intelligent devices, dumb devices, etc., such as (without limitation) washing machines, dryers, watches, wristbands, bangles, home security systems, thermostats, automobile computers, skateboards, medical equipment, sensors, pet equipment or toys, children toys, pool equipment, laps, televisions, coffee machines, stoves, shirts, hats, shoes, jewelry, glasses, sporting equipment, rocks, trees, etc. It is therefore contemplated that participating device 250 may include a range of levels of capabilities, such as computing capabilities, networking capabilities, performance capabilities, etc.

In one embodiment, base computer 230 (e.g., mobile computing device, such as smartphone, tablet computer, etc.) may host dynamic device control application (“control application”) 231 which may include one or more components, such as (without limitations): discovery logic 233, signature/key logic 235, authorization logic 237, policy document logic 239, and user interface 241. Base computer 230 may further include communication logic 243 and storage medium 245. In one embodiment, base computer 230 may belong to a user who may have access to both base and participating devices 230, 250 over network 220.

Now referring to participating device 250 (e.g., washer/dryer, thermostat, etc.), for example, it may also belong to the same user such that the user may have access to both base and participating devices 230, 250 over network 220. In one embodiment, participating device 250 may host dynamic device participation application (“participation application”) 251 which may include one or more components, such as (without limitations): announcement logic 253, signature/key logic 255, reception/evaluation logic 257, and user interface 259. Participating device 250 may further include communication interface 261.

Throughout this document, terms like “logic”, “component”, “module”, “framework”, and “engine” may be referenced interchangeably and include, by way of example, software, hardware, and/or any combination of software and hardware, such as firmware. Further, any use of a particular brand, word, or term, such as “cryptography”, “public key”, “private key”, “signature”, “Internet of Things” or “IoT”, “Cloud of Things” or “CoT”, “OAuth”, “HMAC”, “GUID”, “token”, “participation device”, “base device”, etc., should not be read to limit embodiments to software or devices that carry that label in products or in literature external to this document.

In one embodiment, base device 230 may serve as the user's main or controlling device which may be paired with the user's participation device 250 which, as aforementioned, may include minimal computing and networking capabilities. In having two computing devices 230, 250 paired together and placed in the same network 220 (e.g., IoT), so that both devices 230, 250 along with their user may be efficiently authenticated and verified. It is contemplated that base device 230 is not limited to any particular number and type of particular type of computing devices, such as a smartphone, etc., but that base device 230 may include any number and type of computing device, such as multiple smartphones, laptops, desktops, etc., belonging to the same user (or other authorized users, such as family members, friends, associates, etc.) paired with participating device 250. Similarly, participating device 250 is not limited to any particular number and type of devices and that multiple devices (e.g., washer/dryers, responder, bracelet, watch, home security, thermostat, medical devices, etc.) offering varying services may be made to participate over the same network 220 (e.g., IoT) and paired with any number and type of base devices 230.

In one embodiment, participating device 250 may announce its presence in network 220 as facilitated by announcement logic 253 of participation application 251. For example, using announcement logic 253, a signal and other relevant data may be broadcast over network 220, such as the Internet, IoT, LAN, WiFi, proximity network, Bluetooth, etc. The signal may be detected by base computer 230 via discovery logic 233 of control application 231. In one embodiment, the signal may include a number and type of unique identification (“ID”) forms (such as globally unique identifier (“GUID”), media access control (“MAC”) address, factory-provisioned ID, XAdES, etc.) relating to and identifying participating device 250. In additional to the signal, announcement logic 253 may also broadcast other relevant data relating to participating device 250, such as (without limitation): minimum/maximum capabilities of participating device 250, desired capabilities or participation of participating device 250, identifying signature and/or public key, etc. It one embodiment, signature and/or public key may factory-provisioned or dynamically created using signature/key logic 255 of participation application 251.

In one embodiment, upon detecting the signal and other relevant data via discovery logic 233, control application 231 of base device 230 may then begin to identify and authenticate participating device 250 by identifying, verifying, and authenticating the signal and any other signal using one or more services (such as a core cloud service, etc.) and various authentication standards and protocols (such as OAuth, etc.) as facilitated by signature/key logic 235 and/or authentication logic 237. For example, signature/key logic 235 may be used to verify the public key associated with base device 230 to confirm that there is a private key associated with base device 230. Similarly, authentication logic 237 may verify other information and performing authentication to, for example, the core cloud service using various standards, protocols, services, etc., such as OAuth. It is contemplated that OAuth refers to an open standard for authorization which allows client applications a secure delegated access to server resources on behalf of a resource owner which can authorize the access without having to share their credentials.

Further, as part of the aforementioned authentication process, any unique IDs associated with participating device 250 as provided by announcement logic 253 and detected or received by discovery logic 233 may be forwarded on to device management mechanism 110 at server computer 100 via communication logic 243 and communication/compatibility logic 209. In one embodiment, these unique IDs may be received by reception/detection logic 201 and used by verification logic 205 to verify the identities of both devices 230, 250 and any applications, such as control application 231, participation application 251, etc. Once the identities have been verified by verification logic 205, authorization logic 207 may then authorize both participation and base devices 230, 250 as well as device control and participation applications 231, 251.

Further, in response to the authentication of participating device 250, a private key may be generated by signature/key logic 235 and a corresponding public kay be registered with the user's account via signature/key logic 235 such that participating device 250 may be authorized, via authentication logic 237, to act on the user's behalf using these keys and any other protocols or tokens (e.g., security token, barrier token) may be used.

For example and in one embodiment, security tokens may be defined or determined by, for example, a system administrator associated with server computer 100 such that a security token may be generated by security token logic 203. Further, the security token may have one or more attributes, such as (without limitation) application programming interface (API) name, display name, validity period (e.g., how long the token may survive), audiences, permission set (e.g., to define an act on behalf of capabilities), checkbox to include custom attributes, and checkbox to include customer permissions.

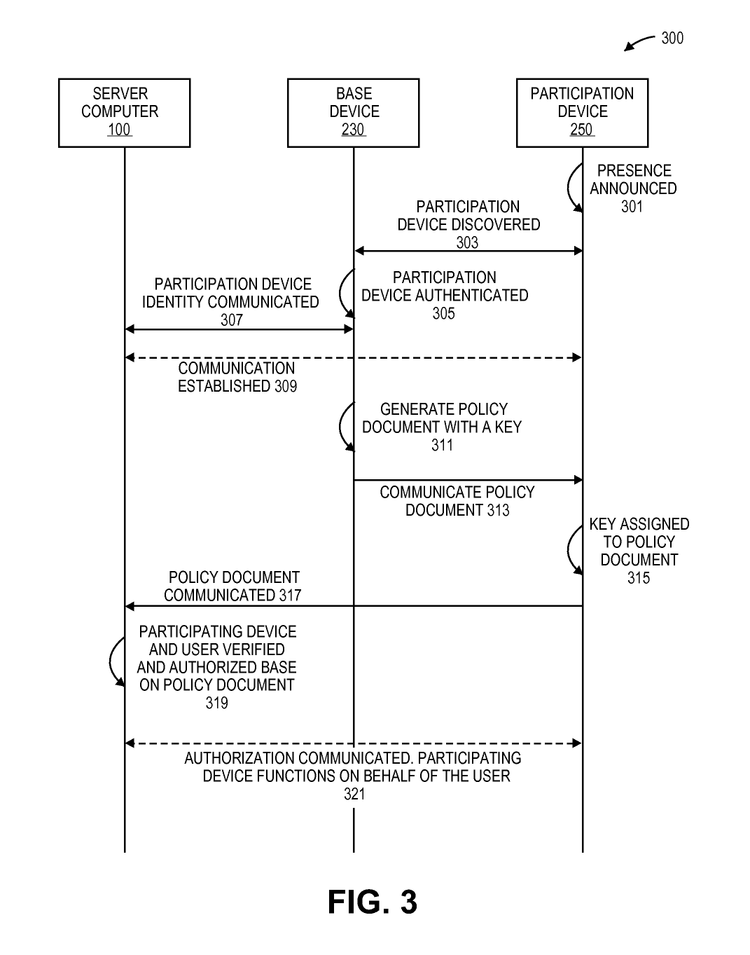

In one embodiment, the authorization request (e.g., OAuth authorization request) from base device 230 may be used to request token logic 203 to allow base device 230 to issue the security token to participating device 250 and return a regular token in response. For example and in one embodiment, the security token issued by base device 230 to the participating device 250 may include a recitation, such as (without limitation): “allow [name of the participating device 250] to act on my behalf”. Upon verification and authentication of the authorization request by verification logic 203 and authentication logic 205, respectively, a request for security token (“security token request”) may be generated by base device 230 and communicated over to server computer 100 for authentication and approval. For example, the security token request may include any amount and type of identifying data (e.g., unique identifiers, optional names, public/private keys, signature, certificates, etc.) as is further described with respect this FIG. 2 and FIG. 3.

This security token request may include an access token seeking for seeking the security token, where the access token may contain or be associated with any amount and type of identifying and other data. For example and in one embodiment, upon receiving the security token request, verification logic 203 may perform any number and type of tasks to verify one or more of the user, base device 230, and participating device 250. Such tasks may include (without limitations) checking to determine whether the access token is valid, the subject of the access token includes a unique device identification (e.g., client_id associated with the base device) that has taken a token of the requested type (e.g., as defined in the policy document), the access token has the rights to issue security tokens of that type, the subject of the request includes a unique device identifier that matches the device unique identifier which the presented access token was previously issued, the subject matches the subject of the presented access token, and verify and authenticate any signatures on the actor JWT.

Upon verifying the security token request by verification logic 203, the security token request may then be authorized by authorization logic 205. For example, upon approval of the security token request an entry (e.g., IssuedSecurityToken, etc.) and/or additional data relating to the user and/or base device (e.g., unique user identifier, unique device identifier, issue date and time, expiration date and time, etc.) may be added to database 215 regarding the authorized security token request. It is contemplated that in some embodiments, when necessary or desired, the security token may be revoked for any number of reasons, such as reaching the token time expiration time, participating device 250 or base device 230 withdrawing participation of participating device 250, etc.

In one embodiment, a policy document may be generated via policy document logic 239 of control application 231, where the policy document may include any amount and type of metadata relating to one or more of participating device 250, base device 230, and the user. For example, the policy document may include the metadata relating to participating device 250, such as its unique ID, capabilities, public key, etc. Similarly, the policy document may include metadata relating to the user of devices 230, 250, such as a core identifier associated with the user, etc.). The policy document may include additional security/performance metadata, such as time or resource constraints of participating device 250, performance and/or involvement of participating device 250 as desired or anticipated by the user, etc.

In one embodiment, the policy document, once generated, may then be assigned, via signature/key logic 235, a signature or private key, such as the user's private key, for security and authentication purposes. In some embodiments, this assignment of signature or private key may be performed by verification logic 205 at server computer 110 on behalf of the user. Further, for example, the policy document may be assigned a signature with a security token (e.g., shared secret) and negotiated with a security protocol, such as OAuth, using an algorithm, such as a keyed-hash message authentication code (“HMAC”) which may be used for calculating, for example, a MAC address having a cryptographic hash function along or in combination with a secret cryptographic key. It is contemplated that “public key” and “private key” refer to secret cryptographic keys. A cryptographic key may include information to determine a function output of a cryptographic algorithm or cipher. Such keys may be used in cryptographic algorithms, such as digital signatures, MACs, etc.

In one embodiment, this policy document may be forwarded on to participating device 250 via communication logic 243, 261 where it is received by reception/evaluation logic 257. Participating device 250 may assign the received policy document its own signature/private key using signature/key logic 255. Upon this assignment, participation device 250 may then transmit the policy document to server computer 100 where it is received by reception/detection logic 201 for further processing.

Once the policy document is received via reception/detection logic 201, the aforementioned contents of the policy document may then be used by verification logic 205 for verification purposes. For example and in one embodiment, verification logic 205 evaluate and cross-check the content (e.g., unique IDs, MAC address, HMAC, device signature, etc.) to verify that participating device 250 is the proper device that is making the request. Similarly, verification logic 205 may also access the user identifying data (e.g., user's signature, public/private key, etc.) contained within the content of the policy document to verify the user, such that the user is who they claim and that participating device 250 is associated with this particular user. It is contemplated and as aforementioned, a cryptographic key (e.g., private key, public key, etc.) may be dynamically generated via signature/key logic 235, 255 or it may be factory-provisioned. For example, in case the cryptographic key is factory-provisioned, verification logic 205 may verify that the corresponding device, such as participating device 250, is generated by a proper factory and that it is not an impersonating device.

In one embodiment, upon proper verification by verification logic 205, as described above, authorization logic 207 may then be triggered and proceed with authorizing participating device 250 to participate and communicate within network 220 (e.g., IoT) in order to perform its functions and tasks on behalf of the user and/or as defined in the policy document (e.g., rights, authority, system constraints, user restrictions, etc.). This way, in one embodiment, using one or more of device management mechanism 110, control application 231, and participation application 251, the user may delegate the necessary and/or relevant authority to participating device 250 to act and function and behalf of the user. This allows a participating device, such as participating device 250, which may have limited or minimal capabilities to function, despite minimal capabilities, to function at a higher level within network 220 (e.g., IoT).

The security token may then be used, via security token logic 203, to identify participating device 250 and that it has the permission to act on behalf of the user (e.g., paired with participating device 250 over a cloud service over network 220). For example, participating device 250 may pass the security token to its cloud, over network 220, and the security token may validate the signature associated with the security token and further verify that the security token and/or signature was issued by a proper issuing agency, such as by security token logic 203 at server computer 100 at Salesforce®, etc., where issuing an ID token (e.g., call a key endpoint and fetch the key, then validate the signature) and subsequently, determine the user and participating device 250.

In one embodiment, upon verifying and using the security token and needing delegation capabilities, using delegation logic 208, the security token and/or signature may be forwarded on to a token endpoint, such as via an OAuth 2 assertion flow, and prove the ability to act on behalf of the user buy constructing a JWT that may appear as follows: outerheader.base64url(innerheader.body.innersignature).outersignature. The outer signature may be performed with a private key corresponding to the key that may have been signed into the security token which verifies the possession of the private key and the ability of the participating device to act on behalf of the user as facilitated by delegation logic 208.

Moreover, as desired or necessary, if the token is to be revoked by server computer 100 as facilitated by device management mechanism 110, or by the user as facilitated by control application 231, the aforementioned authorization and/or participation of participation device 250 may be terminated. Further, server computer 100 may be in communication with database 215 which serves as a repository where any amount and type of data (e.g., policy document, etc.) may be stored. Similarly, storage medium 245 may be used to store policy documents and any amount and type of other data at base device 230.

It is contemplated that in some embodiments, public and private keys, signatures, fingerprints, etc., may be generated using any number and type of algorithms (e.g., cryptographic algorithm). For example, public/private keys may be generated using a cryptographic algorithm, such as Diffie-Hellman key exchange, etc., and similarly, signatures may be generated using a signature algorithm, such as Digital Signature Algorithm, etc., while some algorithms (e.g., Rivet, Shamir and Adleman (“RSA”), etc.) may be used for performing multiple or global functions, such as generating and maintaining keys, signatures, and fingerprints, etc.

It is contemplated that embodiments are not limited to any particular cryptography-related forms or standards (e.g., GNU Privacy Guard (“GPG” or “GnuPG”), Pretty Good Privacy (“PGP”), etc.). Typically, a public or private key may include a long string of alpha-numeric and other characters, appearing as gibberish to the human eye. For example, a Pretty Good Privacy (“PGP”)-based private/public key may appear as follows: mQINBFPOzTUBEADTlkIEMYlIx+9DyNfGHE9HPjLSI/Ybnsn/bbx8cWmeAktoYjBS . . . YyyyH5jej2NP0FuP9jjl8eYgSZl9tqaU6Y9vDyXzE0h6F4SUPiBx3hEIrVzFJym0.

Similarly, as aforementioned, a signature may also include a long string of alpha-numeric and other characters and appear as follows: iEYEARECAAYFAjdYCQoACgkQJ9S6ULt1dqz6IwCfQ7wP6i/i8HhbcOSKF4ELyQB1oCoAoOuq pRqEzr4kOkQqHRLE/b8/Rw2k=y6kj.

Communication/compatibility logic 209 may facilitate the ability to dynamically communicate and stay configured with any number and type of software/application developing tools, models, data processing servers, database platforms and architectures, programming languages and their corresponding platforms, etc. Communication/compatibility logic 209 further facilitates the ability to dynamically communicate and stay configured with various computing devices (e.g., server computing device, mobile computing devices, such as smartphones, tablet computers, laptop, etc.), databases, repositories, networks (e.g., cloud network, Cloud of Things, Internet of Things, intranet, the Internet, proximity network, such as Bluetooth®, WiFi®, etc.), websites (e.g., social networking websites, such as Facebook®, LinkedIn®, Google+®, Twitter®, etc.), and the like, while ensuring compatibility with changing technologies, parameters, protocols, standards, etc.

It is contemplated that any number and type of components may be added to and/or removed from device management mechanism 110, control application 231, and/or participation application 251, etc., to facilitate various embodiments including adding, removing, and/or enhancing certain features. For brevity, clarity, ease of understanding, many of the standard and/or known components, such as those of a computing device, are not shown or discussed here. It is contemplated that embodiments are not limited to any particular technology, topology, system, architecture, and/or standard and are dynamic enough to adopt and adapt to any future changes.

FIG. 3 illustrates a transaction sequence 300 for facilitating dynamic management of devices participating in a network according to one embodiment. Transaction sequence 300 may be performed by processing logic that may comprise hardware (e.g., circuitry, dedicated logic, programmable logic, etc.), software (such as instructions run on a processing device), or a combination thereof. In one embodiment, transaction sequence 300 may be performed by device management mechanism 110, control application 231, and/or participation application 251 and protection application 240 of FIG. 2. The processes of transaction sequence 300 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-2 may not be repeated hereafter.

Transaction sequence 300 begins with participating device 250 announcing its presence within a network (e.g., IoT) at 301. This announcement may be detected at base device 230 and thus, participating device 250 is discovered at 303. At 305, participation device 250 is authenticated. Any identification data (e.g., unique ID) relating to participating device 250 may be communicated to server computer 100 by base device 230 at 307 and communication may be established between server computer 100, base device 230, and participating device 250 at 309.

In one embodiment, a policy document having identifying data relating to participating device and/or the user as well as other relevant information (e.g., system constraints and/or allowances of participating device 250, user expectations and/or restrictions relating to participating device 250, functionalities and/or tasks assigned to participating device 250, etc.) may be generated at base device 230 at 311. Further, a private key corresponding to the user and/or base device 230 may be associated with the policy document. This policy document may then be communicated to participation device 250 at 313. At 315, another private key corresponding to participation device 250 is assigned to the policy document. At 317, the policy document is then forwarded on to server computer 100.

In one embodiment, participating device 250 and/or the user are verified and authenticated at server computer 100 using the contents (e.g., identifying data, such as signatures, keys, IDs, etc.) of the policy document at 319. Similarly, at 319, using the policy content (e.g., constraints, allowances, expectations, tasks, etc.) of the policy document, participating device 250 is authorized to function on behalf and under control of the user. At 321, the authorization is communicated to participating device 250 which then begins participating and functioning within network 220 (e.g., IoT) on behalf of the user and in accordance with the policy-based content of the policy document.

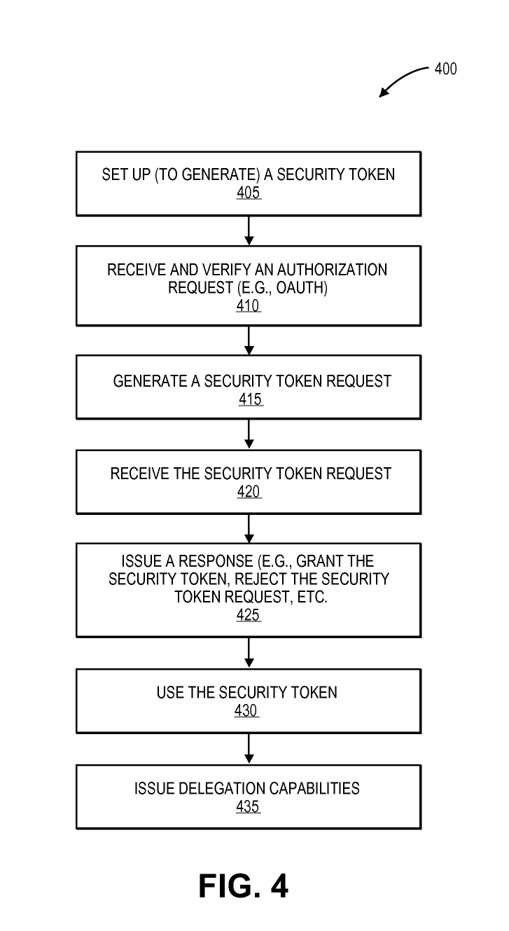

FIG. 4 illustrates a method 400 for facilitating dynamic management of devices participating in a network according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed by management mechanism 110, control application 231, and/or participation application 251 of FIG. 2. The processes of method 400 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-4A may not be repeated hereafter

Method 400 begins at block 405 where security tokens may be set up by, for example, a system administrator associated with a server computer, such as server computer 100 of FIG. 2, where a security token may be generated via security token logic 203 of management mechanism 110 of FIG. 2. A security token may include any number and type of attributes, such as (without limitation) application programming interface (API) name, display name, validity period (e.g., how long the token may survive), audiences, permission set (e.g., to define an act on behalf of capabilities), checkbox to include custom attributes, and checkbox to include customer permissions.

At block 410, in one embodiment, as further described with respect to FIGS. 2-3, a base device, such as base device 230 of FIG. 2, may place an authorization request (e.g., OAuth authorization request) with the server computer to verify the base device and a user associated with the base device so that a security token may be generated at the server computer and forwarded on to the base device so that the security token may then be assigned to a participating device, such as participating device 250 of FIG. 2, which may be returned with a regular token in response. In one embodiment, for example, security token issued by the base device to the participating device may include one or more recitations, such as (without limitation): “allow [name of the participating device] to act on my behalf”.

At bock 415, upon approval of the authorization request and setting up of an authenticated communication between the server computer and the base device, a request for security token may be generated by the base device and then forwarded on to the server computer for verification and authorization. For example, such a security token request may include any amount and type of user and/or device identifying data (e.g., unique identifiers, optional names, public/private keys, signature, certificates, etc.) as is further described with reference to FIGS. 2-3.

At block 420, in one embodiment, the security token request generated by the base device is then communicated to the server computer for verification and authorization. In one embodiment, the security token request may include an access token seeking the security token, where the access token may include or be associated with any amount and type of user and/or device identifying data. For example and in one embodiment, upon receiving the security token request, the server computer may perform any number and type of tasks to verify and authenticate the user, the base device, and/or the participating device as described with reference to FIGS. 2-3.

For example, such verification/authentication tasks may include (without limitations) checking to determine whether: the access token is valid; the subject of the access token includes a device identifier (e.g., client_id associated with the base device) that has taken a token of the requested type (e.g., as defined in the policy document); the access token has the rights to issue security tokens of that type; the subject of the request includes a device identifier (e.g., client_id) that matches the other device identifier (e.g., client_id) for which the presented access token is issued; the subject matches the subject of the presented access token. The server device may further verify and authenticate any signatures on the actor JWT.

At block 425, once the security token request is verified and authenticated at the server computer, the security token request may then be authorized or allowed by the server computer. For example, upon approval of the security token request, one or more entries (e.g., IssuedSecurityToken, etc.) and/or additional data (e.g., unique user identifier, unique device identifier, issue date and time, expiration date and time, etc.) relating to the user and/or base device may be added to a database, such as database 215 of FIG. 2.

At block 430, the security token may then be used to identify the participating device and that it has the permission to act on behalf of the user (e.g., at the cloud service paired with the participating device). For example, the participating device may pass the token to its cloud and the token may validate the signature associated with the token and further verify that the token and/or signature was issued by a proper issuing agency (e.g., server computer at Salesforce®, etc.), such as an ID token (e.g., call a key endpoint and fetch the key, then validate the signature) and subsequently, determine the user and the participating device. Continuing with the example, if, for example, the cloud backend is the proper issuing agency, it may first get a session with a limited capacity using delegation at block 435.

At block 435, in one embodiment, needing delegation capabilities, the token and/or signature may be forwarded on to a token endpoint, such as via an OAuth 2 assertion flow, and prove the ability to act on behalf of the user buy constructing a JWT that may appear as follows: outerheader.base64url(innerheader.body.innersignature).outersignature. The outer signature may be performed with a private key corresponding to the key that may have been signed into the security token which verifies the possession of the private key and the ability of the participating device to act on behalf of the user.

Further, for example, if the participating device does not have keying material, the token may then be posed as a JWT bearer assertion flow, such as POST/services/oauth2/token HTTP/1.1, Host: login. example.com, Content-Type: application/x-www-form-urlencoded, and grant_type=urn %3Aietf %3Aparams %3Aoauth %3Agrant-type %3Ajwt-pop&assertion=PHNhbWxwOl . . . [omitted for brevity] . . . ZT. At the server computer, the token endpoint may then perform the following operations: 1) verify that the outer signature matches the public key; 2) verify that the public key matches the JWK signed into the inner ID token; 3) verify that the signature on the security token is valid; and 4) verify that the security token ID has not been revoked. The endpoint may then issue a token response. Further, the access token may be scoped to a permission set associated with the security token. For example, if it only provides CRUD on case, then that is all that may be allowed for that token. The permission set may not be able to escalate the permissions of the user's license and a line may be written in the login history tracking the exchange. It is contemplated that in some embodiments, when necessary or desired, the issued or granted security token may be revoked for any number of reasons, such as expiration of the security token time limit, the participating device or the base device withdrawing participation of the participating device, etc.

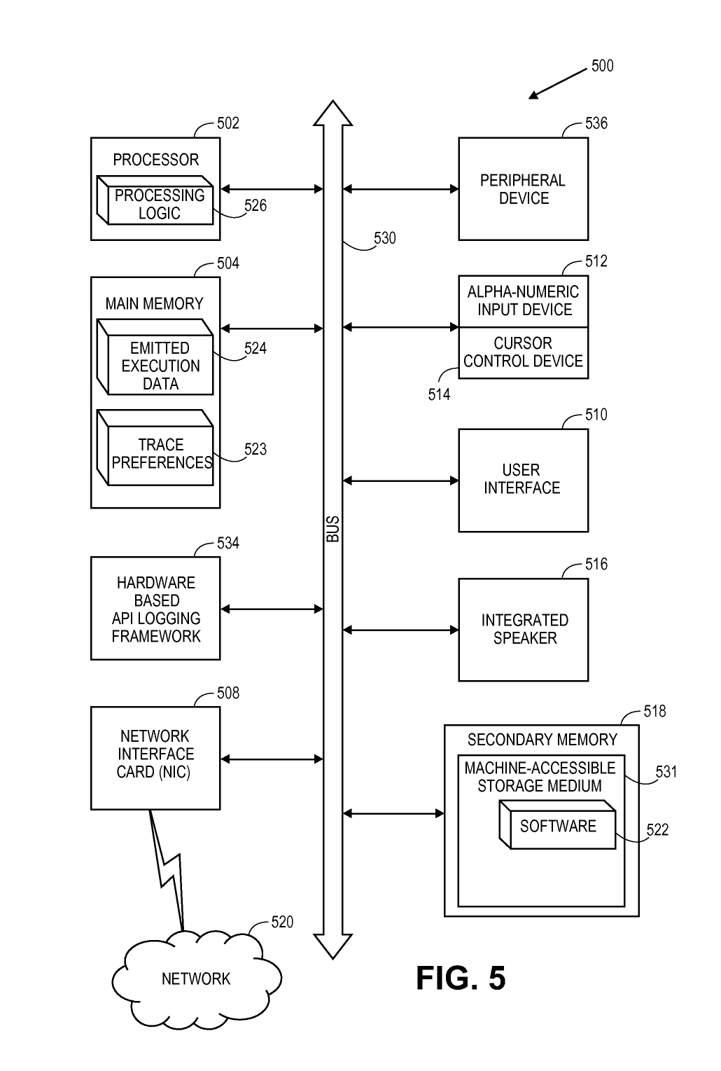

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing devices 100, 230, 250 of FIGS. 1-2. In alternative embodiments, the machine may be connected (e.g., networked) to other machines in a network (such as host machine 100 of FIG. 1 connected with client machines 230, 250 over network 220 of FIG. 2), such as Internet of Things (“IoT”) or Cloud of Things (“CoT”), a cloud-based network, a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of dynamic database table and customer query management mechanism 110 as described with reference to FIG. 1 other figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of protection mechanism 110 as described with reference to FIG. 1 and other figures discussed herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

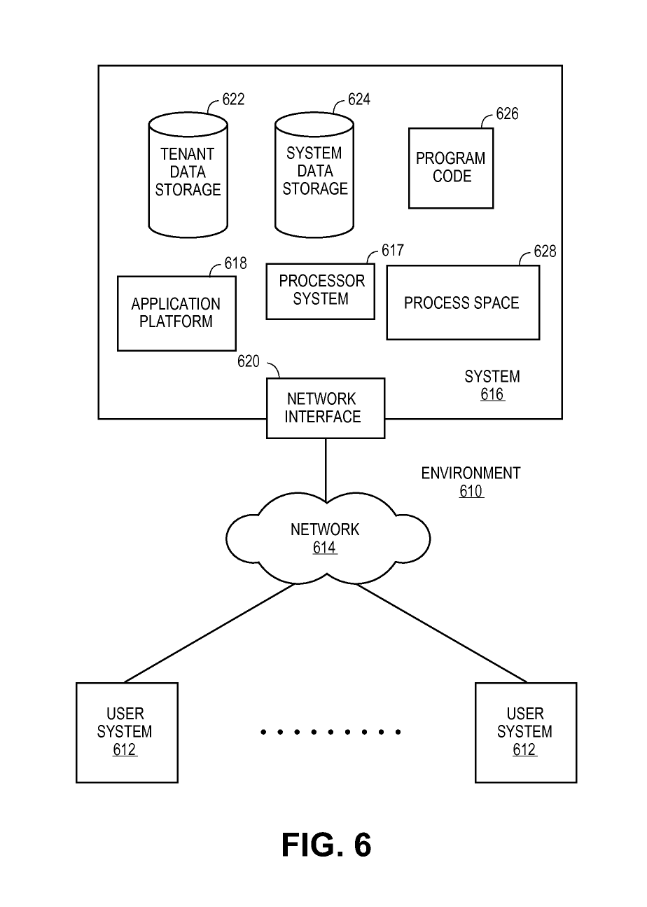

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

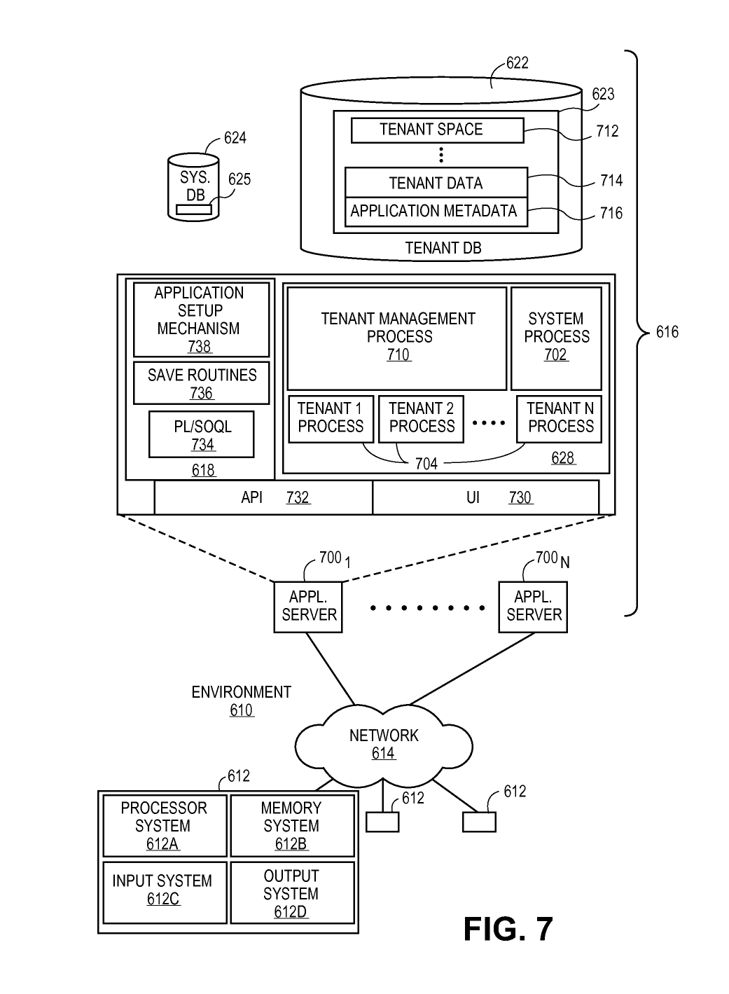

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. User system 612 further includes Mobile OS (e.g., iOS® by Apple®, Android®, WebOS® by Palm®, etc.). Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A method comprising:
receiving, by and incorporating into a database system, a policy document relating to a first computing device over a network, the network including Internet of Things (“IoT”);
verifying, by the database, the first computing device based on contents of the policy document; and
authorizing, by the database, the first computing device to participate within the network, wherein participating includes performing one or more tasks within the network on behalf of a user and in accordance with the policy document.

2. The method of claim 1, wherein the policy document comprises identifying data relating to the first computing device and the user, wherein the policy document further comprises policy information relating to one or more of computing capabilities, networking capabilities, and performance capabilities of the first computing device, and wherein the policy information further relates to expectations of the user regarding the one or more tasks to be perform by the first computing device.

3. The method of claim 1, wherein verifying comprising identifying and authenticating the first computing device based on one or more unique device identifiers obtained from the identifying data of the policy document, wherein verifying further comprises identifying and authenticating the user based on one or more unique user identifiers obtained from the identifying data of the policy document.

4. The method of claim 3, wherein the one or more unique device identifiers comprise one or more of a globally unique identifier (“GUID”), a media access control (“MAC”) address, a factory-provisioned identifier, an Extensible Markup Language Advanced Electronic Signature (“XAdES”), a JavaScript Object Notation (“JSON”) Web Token (“JWT”), and an OAuth refresh token.

5. The method of claim 1, wherein the policy document is generated at a second computing device coupled with the first computing device over the network, wherein the second computing device serves as a base computer that is accessible by the user of the first computing device serving as a participating device.

6. The method of claim 1, wherein the policy document is generated in response to the first computing device announcing its presence within the network, and wherein the policy device is assigned security tokens relating to one or more of the first computing device, the second computing device, and the user, wherein the security tokens include one or more of a digital signature and a cryptographic key.

7. The method of claim 6, wherein the first computing device and one or more devices participating within the IoT comprise one or more of washers, dryers, watches, wristbands, bangles, home security systems, thermostats, automobile computers, skateboards, medical equipment, sensors, pet equipment or toys, children toys, pool equipment, laps, televisions, coffee machines, stoves, shirts, hats, shoes, jewelry, glasses, sporting equipment, rocks, and trees.

8. An apparatus comprising:
reception/detection logic to receive, by and incorporating into a database system, a policy document relating to a first computing device over a network, the network including Internet of Things (“IoT”);
verification logic to verify, by the database, the first computing device based on contents of the policy document; and
authorization logic to authorize, by the database, the first computing device to participate within the network, wherein participating includes performing one or more tasks within the network on behalf of a user and in accordance with the policy document.

9. The apparatus of claim 8, wherein the policy document comprises identifying data relating to the first computing device and the user, wherein the policy document further comprises policy information relating to one or more of computing capabilities, networking capabilities, and performance capabilities of the first computing device, and wherein the policy information further relates to expectations of the user regarding the one or more tasks to be perform by the first computing device.

10. The apparatus of claim 8, wherein verifying comprising identifying and authenticating the first computing device based on one or more unique device identifiers obtained from the identifying data of the policy document, wherein verifying further comprises identifying and authenticating the user based on one or more unique user identifiers obtained from the identifying data of the policy document.

11. The apparatus of claim 10, wherein the one or more unique device identifiers comprise one or more of a globally unique identifier (“GUID”), a media access control (“MAC”) address, a factory-provisioned identifier, an Extensible Markup Language Advanced Electronic Signature (“XAdES”), a JavaScript Object Notation (“JSON”) Web Token (“JWT”), and an OAuth refresh token.

12. The apparatus of claim 8, wherein the policy document is generated at a second computing device coupled with the first computing device over the network, wherein the second computing device serves as a base computer that is accessible by the user of the first computing device serving as a participating device.

13. The apparatus of claim 8, wherein the policy document is generated in response to the first computing device announcing its presence within the network, and wherein the policy device is assigned security tokens relating to one or more of the first computing device, the second computing device, and the user, wherein the security tokens include one or more of a digital signature and a cryptographic key.

14. The apparatus of claim 13, wherein the first computing device and one or more devices participating within the IoT comprise one or more of washers, dryers, watches, wristbands, bangles, home security systems, thermostats, automobile computers, skateboards, medical equipment, sensors, pet equipment or toys, children toys, pool equipment, laps, televisions, coffee machines, stoves, shirts, hats, shoes, jewelry, glasses, sporting equipment, rocks, and trees.

15. A machine-readable medium comprising a plurality of instructions which, when executed by a processing device, cause the processing device to perform one or more operations comprising:
receiving, by and incorporating into a database system, a policy document relating to a first computing device over a network, the network including Internet of Things (“IoT”);
verifying, by the database, the first computing device based on contents of the policy document; and
authorizing, by the database, the first computing device to participate within the network, wherein participating includes performing one or more tasks within the network on behalf of a user and in accordance with the policy document.

16. The machine-readable medium of claim 15, wherein the policy document comprises identifying data relating to the first computing device and the user, wherein the policy document further comprises policy information relating to one or more of computing capabilities, networking capabilities, and performance capabilities of the first computing device, and wherein the policy information further relates to expectations of the user regarding the one or more tasks to be perform by the first computing device.

17. The machine-readable medium of claim 15, wherein verifying comprising identifying and authenticating the first computing device based on one or more unique device identifiers obtained from the identifying data of the policy document, wherein verifying further comprises identifying and authenticating the user based on one or more unique user identifiers obtained from the identifying data of the policy document.

18. The machine-readable medium of claim 17, wherein the one or more unique device identifiers comprise one or more of a globally unique identifier (“GUID”), a media access control (“MAC”) address, a factory-provisioned identifier, an Extensible Markup Language Advanced Electronic Signature (“XAdES”), a JavaScript Object Notation (“JSON”) Web Token (“JWT”), and an OAuth refresh token.

19. The machine-readable medium of claim 15, wherein the policy document is generated at a second computing device coupled with the first computing device over the network, wherein the second computing device serves as a base computer that is accessible by the user of the first computing device serving as a participating device.

20. The machine-readable medium of claim 15, wherein the policy document is generated in response to the first computing device announcing its presence within the network, and wherein the policy device is assigned security tokens relating to one or more of the first computing device, the second computing device, and the user, wherein the security tokens include one or more of a digital signature and a cryptographic key, wherein the first computing device and one or more devices participating within the IoT comprise one or more of washers, dryers, watches, wristbands, bangles, home security systems, thermostats, automobile computers, skateboards, medical equipment, sensors, pet equipment or toys, children toys, pool equipment, laps, televisions, coffee machines, stoves, shirts, hats, shoes, jewelry, glasses, sporting equipment, rocks, and trees.
